(19) United States
(12) Patent Application Publication
(10) Pub. No.: US 2025/0347547 A1
(43) Pub. Date: Nov. 13, 2025

(54) OIL-IMMERSED TRANSFORMER AND OIL LEVEL DETECTION DEVICE THEREOF

(71) Applicant: Fortune Electric Co., Ltd., Taoyuan City (TW)

(72) Inventors: CHIA-CHING LIN, Taoyuan City (TW); CHING-MIN CHEN, Taoyuan City (TW); DI-JIE HUANG, Taoyuan City (TW); YA-HUA LEE, Taoyuan City (TW)

(21) Appl. No.: 19/018,333

(22) Filed: Jan. 13, 2025

(30) Foreign Application Priority Data
May 13, 2024 (TW) 113117519

(51) Int. Cl. G01F 23/292; H01F 27/14

(52) U.S. Cl. CPC G01F 23/292; H01F 27/14

(57) ABSTRACT

An oil level detection device and an oil-immersed transformer. The oil level detection device that includes a detachable oil tank and an optical oil level gauge is applicable to the oil-immersed transformer. The oil-immersed transformer includes an oil storage device for storage of an insulating oil. The detachable oil tank includes a lower tank body disposed on the oil storage device, and an upper tank body disposed above and in spatial communication with the lower tank body. The lower tank body has a second oil chamber that is in spatial communication with a first oil chamber of the oil storage device for circulation of the insulating oil. The optical oil level gauge is disposed on the upper tank body for projecting a sensing beam onto the insulating oil within the second oil chamber and detecting a height change of an oil surface.

### CROSS-REFERENCE TO RELATED PATENT APPLICATION

This application claims the benefit of priority to Taiwan Patent Application No. 113117519, filed on May 13, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a transformer for a power transmission and distribution system, and more particularly to an oil-immersed transformer and an oil level detection device thereof.

### BACKGROUND OF THE DISCLOSURE

An oil-immersed transformer is a commonly seen electrical apparatus, which is to decrease a high voltage to a low voltage or to increase the low voltage to the high voltage. Whether operation of the oil-immersed transformer is stable or not is directly associated with the reliability of power supply of an electrical grid. The main feature of the oil-immersed transformer is immersion of a core and a winding in an insulating oil, so as to enhance an insulation performance of a transformer, prevent malfunction of an electrical appliance, and prevent the occurrence of fire. In addition, the insulating oil can effectively dissipate heat, such that the transformer is maintained in a relatively stable temperature condition, thereby improving its operation efficiency and service life.

Generally, an oil temperature will be increased with an increase in a load of the transformer, and an oil level will also rise due to volume expansion. Conversely, the oil temperature will be decreased with a decrease in the load of the transformer, and the oil level will also be lowered due to volume reduction. Hence, a change in the oil level will reflect a health condition of the transformer. The oil level being too high or too low indicates that an abnormality is likely to be present in the transformer, which may lead to malfunction of the transformer or even accidents. For example, when the oil level is too high, a pressure inside an oil tank will be so increased as to cause oil spillages. When the oil level is too low, an insulation performance of the transformer will be reduced, and an insulation breakdown may occur.

Therefore, an oil level gauge is installed in an oil storage device of the transformer, so as to reflect a real height of the oil level inside the transformer. However, in an electric power system, the oil level gauge (e.g., a pointer-type oil level gauge) that requires on-side reading of an oil level detection value is still installed on most transformers. If the oil level of the operating transformer is abnormal, damage occurs and even worsens since timely detection is often impossible.

### SUMMARY OF THE DISCLOSURE

In response to the above-referenced technical inadequacies, the present disclosure provides an oil-immersed transformer and an oil level detection device thereof. Compared with the conventional technology, the oil-immersed transformer and the oil level detection device provided by the present disclosure are more advantageous in applicability to transformers and monitoring of oil level abnormalities.

In order to solve the above-mentioned problems, one of the technical aspects adopted by the present disclosure is to provide an oil level detection device that is applicable to an oil-immersed transformer. The oil-immersed transformer includes an oil storage device for storage of an insulating oil, and the oil level detection device of the present disclosure includes a detachable oil tank and an optical oil level gauge. The detachable oil tank includes a lower tank body and an upper tank body, the lower tank body is disposed on the oil storage device, and the upper tank body is disposed above and in spatial communication with the lower tank body. The oil storage device has a first oil chamber, and the lower tank body has a second oil chamber that is in spatial communication with the first oil chamber, such that the insulating oil circulates between the first oil chamber and the second oil chamber. The optical oil level gauge is disposed on the upper tank body, and has a light output surface that is positioned in an inner space of the upper tank body, so as to project a sensing beam onto the insulating oil within the second oil chamber and detect a height change of an oil surface.

In order to solve the above-mentioned problems, another one of the technical aspects adopted by the present disclosure is to provide an oil-immersed transformer, which includes an oil storage device and an oil level detection device. The oil storage device is configured for storage of an insulating oil, and has a first oil chamber. The oil level detection device includes a detachable oil tank and an optical oil level gauge. The detachable oil tank includes a lower tank body and an upper tank body, the lower tank body is disposed on the oil storage device, and the upper tank body is disposed above and in spatial communication with the lower tank body. The lower tank body has a second oil chamber that is in spatial communication with the first oil chamber, such that the insulating oil circulates between the first oil chamber and the second oil chamber. The optical oil level gauge is disposed on the upper tank body, and has a light output surface that is positioned in an inner space of the upper tank body, so as to project a sensing beam onto the insulating oil within the second oil chamber and detect a height change of an oil surface.

In one of the possible or preferred embodiments, the oil storage device has a first lateral opening that communicates with the first oil chamber and a first mating portion that surrounds the first lateral opening, the lower tank body has a second lateral opening that communicates with the second oil chamber and a second mating portion that surrounds the second lateral opening, and the first mating portion is mated with the second mating portion to form a sealing engagement.

In one of the possible or preferred embodiments, the first mating portion and the second mating portion are each configured to be a flange structure.

In one of the possible or preferred embodiments, the lower tank body has a top opening and a third mating portion that surrounds the top opening, the upper tank body has a bottom opening and a fourth mating portion that surrounds the bottom opening, and the third mating portion is mated with the fourth mating portion to form the sealing engagement.

In one of the possible or preferred embodiments, the lower tank body includes a main body portion and an extension portion, and an extending direction of the main body portion is perpendicular to an extending direction of the extension portion. The main body portion is configured to have the second oil chamber, the second lateral opening, and the second mating portion, and the extension portion is configured to have the top opening and the third mating portion.

In one of the possible or preferred embodiments, the third mating portion and the fourth mating portion are each configured to be a flange structure.

In one of the possible or preferred embodiments, the upper tank body includes a top cover that is opposite to the bottom opening, and the optical oil level gauge is disposed on the top cover.

In one of the possible or preferred embodiments, the upper tank body includes an oil injection valve that is disposed on the top cover, and the lower tank body includes an oil drain valve that is disposed on the main body portion.

In one of the possible or preferred embodiments, the oil level detection device further includes a support, and the main body portion of the lower tank body is fixed to the support.

Therefore, in the oil-immersed transformer and the oil level detection device thereof provided by the present disclosure, the oil level detection device can be detachably disposed on the oil storage device of the oil-immersed transformer, so as to be applicable to latest and previous transformers at the same time. In addition, by virtue of “the detachable oil tank including a lower tank body and an upper tank body, the lower tank body being disposed on the oil storage device, and the upper tank body being disposed above and in spatial communication with the lower tank body,” “the oil storage device having a first oil chamber, and the lower tank body having a second oil chamber that is in spatial communication with the first oil chamber, such that the insulating oil circulates between the first oil chamber and the second oil chamber,” and “the optical oil level gauge having a light output surface that is positioned in an inner space of the upper tank body, so as to project a sensing beam onto the insulating oil within the second oil chamber and detect a height change of an oil surface,” the height change of the oil surface of the insulating oil can be remotely monitored in real time, and the status of an oil level inside the transformer can be well observed. In this way, a warning is instantly issued when the status of the oil level is abnormal, thereby preventing damage to the transformer.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an oil level detection device according to the present disclosure;

FIG. 2 is another schematic perspective view of the oil level detection device according to the present disclosure;

FIG. 3 is a schematic view showing a use status of the oil level detection device according to the present disclosure;

FIG. 4 is another schematic view showing the use status of the oil level detection device according to the present disclosure; and

FIG. 5 is a schematic view of an oil-immersed transformer according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Unless otherwise stated, the equipment or operation(s) involved in any described embodiment is/are conventional equipment or operation(s) generally known in the related art. It should be noted that, when one component is described to be “connected” or “coupled” to another component, the two components can be directly or indirectly connected or coupled, or an intermediate component can exist therebetween.

In the present disclosure, a non-contact digital oil level gauge is disposed on an oil storage tank of an oil-immersed transformer through a modularization design, so as to be applicable to latest and previous transformers at the same time and achieve the function of remote monitoring. In this way, oil level abnormalities inside the transformer can be detected at once, such that notifications are issued in real time and response measures can be taken.

### First Embodiment

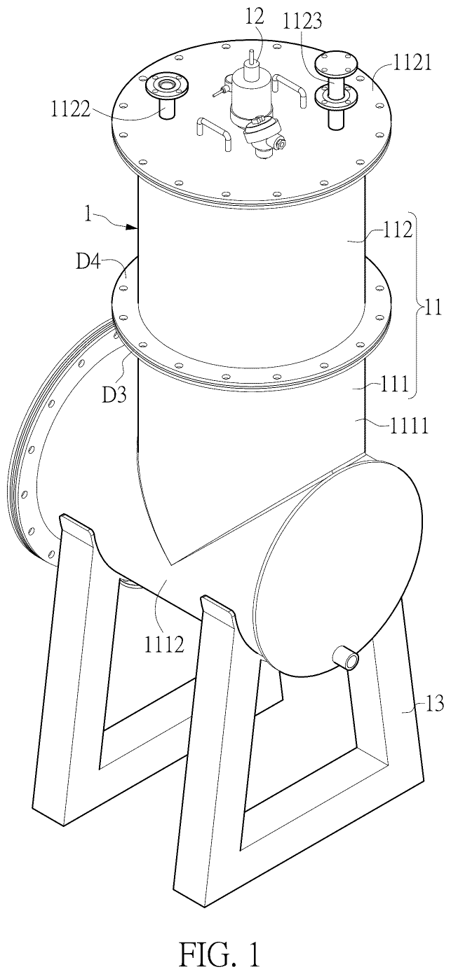

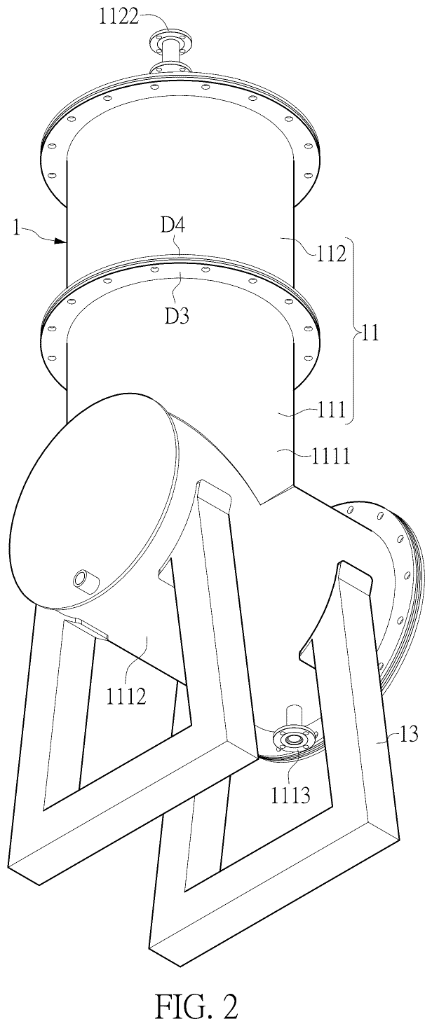

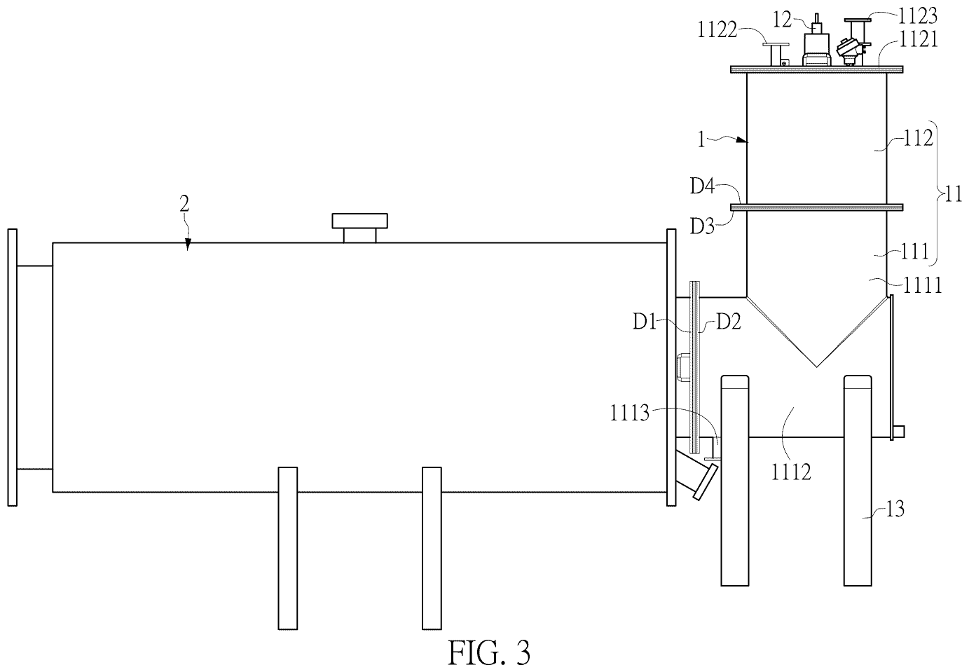

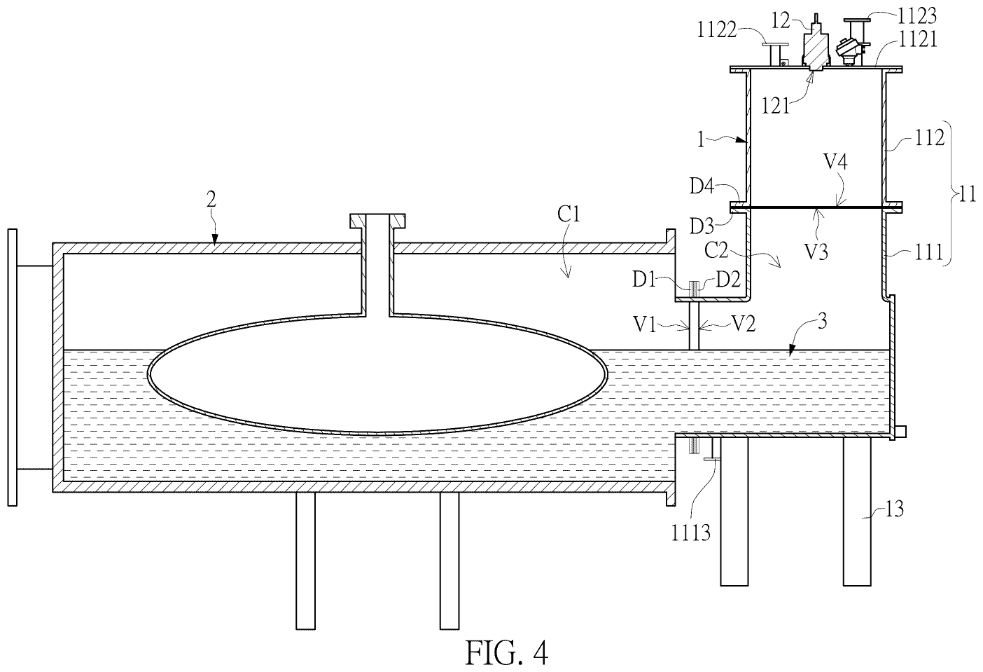

Referring to FIG. 1 to FIG. 4, FIG. 1 and FIG. 2 show the structure of an oil level detection device 1 according to a first embodiment of the present disclosure, and FIG. 3 and FIG. 4 show a use status of the oil level detection device 1 according to the first embodiment of the present disclosure. As shown in the drawings mentioned above, the oil level detection device 1 of the present disclosure is designed to be modularly replaceable, and mainly includes a detachable oil tank 11 and an optical oil level gauge 12. The detachable oil tank 11 can be detachably disposed on an oil storage device 2 (e.g., an oil storage tank) of an oil-immersed transformer, and an insulating oil 3 within the oil storage device 2 will partially flow into the detachable oil tank 11. The optical oil level gauge 12 is disposed on the detachable oil tank 11, and is configured to detect a height of an oil surface of the insulating oil 3 by projection of light.

It is worth mentioning that the optical oil level gauge 12 can periodically collect data associated with the height of the oil surface of the insulating oil 3. For example, real-time data associated with the height of the oil surface during operation of the transformer is collected every ten minutes or one hour, and the optical oil level gauge 12 stores the collected data in a database or transmits the same to a monitoring center. Accordingly, a height change of the oil surface of the insulating oil 3 can be remotely monitored in real time, and the status of an oil level inside the oil-immersed transformer can be well observed. When the status of the oil level is abnormal, a warning is instantly issued, thereby preventing damage to the transformer.

In the present disclosure, the detachable oil tank 11 includes a lower tank body 111 and an upper tank body 112. The lower tank body 111 is attached to one side of the oil storage device 2 in the form of a communicating vessel. The upper tank body 112 is disposed above and in spatial communication with the lower tank body 111. Specifically, the oil storage device 2 has a first oil chamber C1, and the lower tank body 111 has a second oil chamber C2 that is in spatial communication with the first oil chamber C1, such that the insulating oil 3 circulates between the first oil chamber C1 and the second oil chamber C2. In addition, the optical oil level gauge 12 is disposed on the upper tank body 112, and a light output surface 121 of the optical oil level gauge 12 is positioned in an inner space of the upper tank body 112, so as to project a sensing beam onto the insulating oil 3 within the second oil chamber C2 and detect the height change of the oil surface.

In the present embodiment, the oil storage device 2 has a first lateral opening V1 that communicates with the first oil chamber C1 and a first mating portion D1 that surrounds the first lateral opening V1, and the lower tank body 111 has a second lateral opening V2 that communicates with the second oil chamber C2 and a second mating portion D2 that surrounds the second lateral opening V2. The first mating portion D1 is mated with the second mating portion D2 to form a sealing engagement. Here, the first mating portion D1 and the second mating portion D2 are each configured to be a flange structure, and a sealing member (e.g., a sealing gasket) can be disposed between the first mating portion D1 and the second mating portion D2, but the present disclosure is not limited thereto.

As a component of the detachment oil tank 11, the lower tank body 111 has a top opening V3 and a third mating portion D3 that surrounds the top opening V3, and the upper tank body 112 has a bottom opening V4 and a fourth mating portion D4 that surrounds the bottom opening V4. The third mating portion D3 is mated with the fourth mating portion D4 to form the sealing engagement. Here, the third mating portion D3 and the fourth mating portion D4 are each configured to be a flange structure, and a sealing member (e.g., a sealing gasket) can be disposed between the third mating portion D3 and the fourth mating portion D4, but the present disclosure is not limited thereto.

The lower tank body 111 is approximately L-shaped, and includes a main body portion 1112 and an extension portion 1111. An extending direction of the main body portion 1112 is perpendicular to an extending direction of the extension portion 1111. The main body portion 1112 is configured to have the second oil chamber C2, the second lateral opening V2, and the second mating portion D2, and the extension portion 1111 is configured to have the top opening V3 and the third mating portion D3. Furthermore, the upper tank body 112 includes a top cover 1121 that is opposite to the bottom opening V4, and the optical oil level gauge 12 is disposed on the top cover 1121, such that the light output surface 121 corresponds in position to the second oil chamber C2. The shape of the upper tank body 112 and the main body portion 1112 and the extension portion 1111 of the lower tank body 111 are essentially cylindrical. In order to achieve a highly precise detection of the oil level, a sum of a height of the upper tank body 112 and a height of the extension portion 1111 of the lower tank body 111 matches a projection distance of the sensing beam of the optical oil level gauge 12, and an inner width of the upper tank body 112 and an inner width of the extension portion 1111 of the lower tank body 111 match a projection range of the sensing beam of the optical oil level gauge 12.

In practice, the oil level detection device 1 of the present disclosure further includes a support 13, and the main body portion 1112 of the lower tank body 111 is fixed to the support 13. Moreover, the lower tank body 111 can include an oil drain valve 1113 that is disposed on the main body portion 1112, and the upper tank body 112 can include an oil injection valve 1122 and an air discharge valve 1123 that are disposed on the top cover 1121.

### Second Embodiment

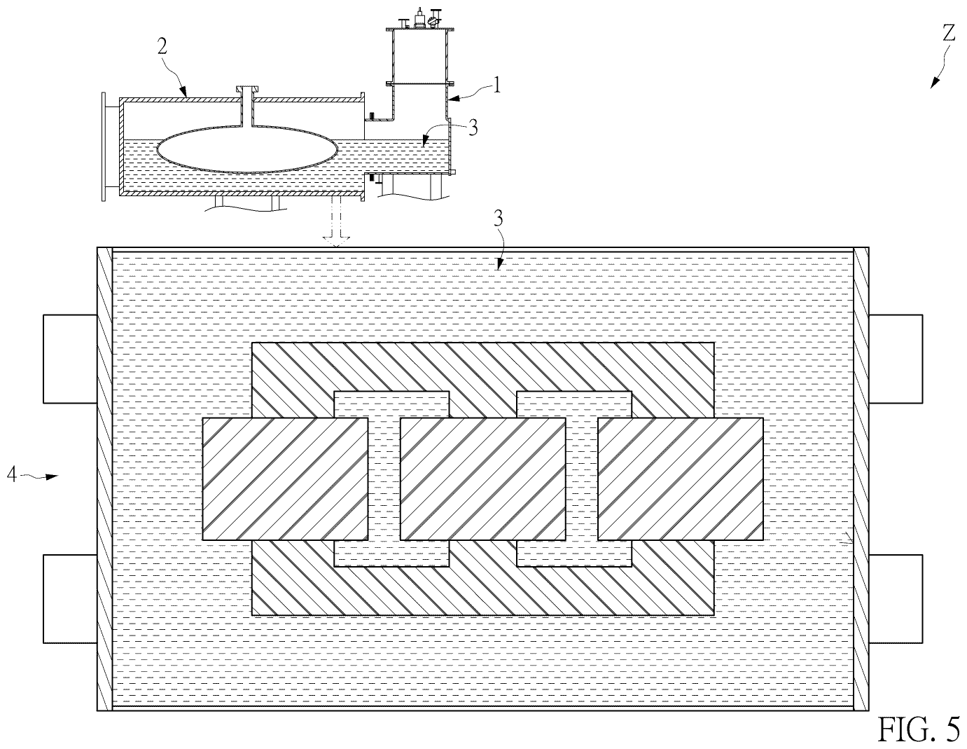

Referring to FIG. 5, which is to be read in conjunction with FIG. 1 to FIG. 4, a second embodiment of the present disclosure provides an oil-immersed transformer Z. The oil-immersed transformer Z includes a transformer body 4, the oil storage device 2, and the oil level detection device 1. The oil storage device 2 is used to store the insulating oil 3. The oil storage device 2 is disposed above the transformer body 4, and is connected to the transformer body 4 through piping, so as to be able to regulate an oil amount and ensure that the transformer body 4 is often filled with oil. The oil level detection device 1 includes the detachable oil tank 11 and the optical oil level gauge 12. The detachable oil tank 11 can be detachably disposed on the oil storage device 2 (e.g., an oil storage tank) of the oil-immersed transformer Z, and the insulating oil 3 within the oil storage device 2 will partially flow into the detachable oil tank 11. The optical oil level gauge 12 is disposed on the detachable oil tank 11, and is configured to detect the height of the oil surface of the insulating oil 3 by projection of light.

In the present embodiment, the detachable oil tank 11 includes the lower tank body 111 and the upper tank body 112. The lower tank body 111 is attached to one side of the oil storage device 2 in the form of a communicating vessel. The upper tank body 112 is disposed above and in spatial communication with the lower tank body 111. Specifically, the oil storage device 2 has the first oil chamber C1, and the lower tank body 111 has the second oil chamber C2 that is in spatial communication with the first oil chamber C1, such that the insulating oil 3 circulates between the first oil chamber C1 and the second oil chamber C2. In addition, the optical oil level gauge 12 is disposed on the upper tank body 112, and the light output surface 121 of the optical oil level gauge 12 is positioned in the inner space of the upper tank body 112, so as to project the sensing beam onto the insulating oil 3 within the second oil chamber C2 and detect the height change of the oil surface.

It is worth mentioning that an air bag (not labeled in the drawings) can be disposed in the oil storage device 2 for separation of the insulating oil 3 and the atmosphere. In the present disclosure, the optical oil level gauge 12 is disposed on the oil storage device 2 through the modularization design. Even if a volume of the air bag is increased, a light projection path of the optical oil level gauge 12 will not be blocked, thereby ensuring that the optical oil level gauge 12 functions normally.

The related technical details mentioned in the first embodiment are still implementable in the present embodiment, and will not be reiterated herein for the sake of brevity. Similarly, the related technical details mentioned in the present embodiment can also be implemented in the first embodiment.

### Beneficial Effects of the Embodiments

In conclusion, in the oil-immersed transformer and the oil level detection device thereof provided by the present disclosure, the oil level detection device can be detachably disposed on the oil storage device of the oil-immersed transformer, so as to be applicable to latest and previous transformers at the same time. In addition, by virtue of “the detachable oil tank including a lower tank body and an upper tank body, the lower tank body being disposed on the oil storage device, and the upper tank body being disposed above and in spatial communication with the lower tank body,” “the oil storage device having a first oil chamber, and the lower tank body having a second oil chamber that is in spatial communication with the first oil chamber, such that the insulating oil circulates between the first oil chamber and the second oil chamber,” and “the optical oil level gauge having a light output surface that is positioned in an inner space of the upper tank body, so as to project a sensing beam onto the insulating oil within the second oil chamber and detect a height change of an oil surface,” the height change of the oil surface of the insulating oil can be remotely monitored in real time, and the status of the oil level inside the transformer can be well observed. In this way, a warning is instantly issued when the status of the oil level is abnormal, thereby preventing damage to the transformer.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An oil level detection device, the oil level detection device being applicable to an oil-immersed transformer, the oil-immersed transformer including an oil storage device for storage of an insulating oil, and the oil level detection device comprising:
a detachable oil tank, wherein the detachable oil tank includes a lower tank body and an upper tank body, the lower tank body is disposed on the oil storage device, and the upper tank body is disposed above and in spatial communication with the lower tank body; wherein the oil storage device has a first oil chamber, and the lower tank body has a second oil chamber that is in spatial communication with the first oil chamber, such that the insulating oil circulates between the first oil chamber and the second oil chamber; and
an optical oil level gauge disposed on the upper tank body, wherein the optical oil level gauge has a light output surface that is positioned in an inner space of the upper tank body, so as to project a sensing beam onto the insulating oil within the second oil chamber and detect a height change of an oil surface.

2. The oil level detection device according to claim 1, wherein the oil storage device has a first lateral opening that communicates with the first oil chamber and a first mating portion that surrounds the first lateral opening, the lower tank body has a second lateral opening that communicates with the second oil chamber and a second mating portion that surrounds the second lateral opening, and the first mating portion is mated with the second mating portion to form a sealing engagement.

3. The oil level detection device according to claim 2, wherein the first mating portion and the second mating portion are each configured to be a flange structure.

4. The oil level detection device according to claim 2, wherein the lower tank body has a top opening and a third mating portion that surrounds the top opening, the upper tank body has a bottom opening and a fourth mating portion that surrounds the bottom opening, and the third mating portion is mated with the fourth mating portion to form the sealing engagement.

5. The oil level detection device according to claim 4, wherein the lower tank body includes a main body portion and an extension portion, and an extending direction of the main body portion is perpendicular to an extending direction of the extension portion; wherein the main body portion is configured to have the second oil chamber, the second lateral opening, and the second mating portion, and the extension portion is configured to have the top opening and the third mating portion.

6. The oil level detection device according to claim 4, wherein the third mating portion and the fourth mating portion are each configured to be a flange structure.

7. The oil level detection device according to claim 5, wherein the upper tank body includes a top cover that is opposite to the bottom opening, and the optical oil level gauge is disposed on the top cover.

8. The oil level detection device according to claim 7, wherein the upper tank body includes an oil injection valve that is disposed on the top cover, and the lower tank body includes an oil drain valve that is disposed on the main body portion.

9. The oil level detection device according to claim 5, further comprising: a support, wherein the main body portion of the lower tank body is fixed to the support.

10. An oil-immersed transformer, comprising:
an oil storage device, wherein the oil storage device is configured for storage of an insulating oil, and has a first oil chamber; and
an oil level detection device including:
a detachable oil tank, wherein the detachable oil tank includes a lower tank body and an upper tank body, the lower tank body is disposed on the oil storage device, and the upper tank body is disposed above and in spatial communication with the lower tank body; wherein the lower tank body has a second oil chamber that is in spatial communication with the first oil chamber, such that the insulating oil circulates between the first oil chamber and the second oil chamber; and
an optical oil level gauge disposed on the upper tank body, wherein the optical oil level gauge has a light output surface that is positioned in an inner space of the upper tank body, so as to project a sensing beam onto the insulating oil within the second oil chamber and detect a height change of an oil surface.
